(19) United States
(12) Patent Application Publication
(10) Pub. No.: US 2003/0157823 A1
(43) Pub. Date: Aug. 21, 2003

(54) Hermetically sealed nuclear instrumentation connector

(76) Inventor: Richard W. Morris, East Granby, CT (US)

Correspondence Address: Joseph C. Spadacene, Westinghouse Electric Company LLC, 4350 Northern Pike, Monroeville, PA, 15146, US

(21) Appl. No.: 10/077,628

(22) Filed: Feb. 19, 2002

(51) Int. Cl. H01R 13/52

(52) U.S. Cl. 439/271

(57) ABSTRACT

An electrical connector that detachably connects a cable having a metal sheath enclosing electrical conductors, to a second set of conductors. The connector is formed from a tubular, elongated housing that is separated into two sections. A first section is metallurgically joined to the sheath of the cable that it is connecting and the cable conductors are coupled to a corresponding number of electrically conductive pins in a second section of the housing to which the first section is then joined. A complementary connector is electrically joined in the same manner to a second cable to which the first cable is to be detachably connected.

### BACKGROUND OF THE INVENTION

1. Field of the Invention

This invention relates generally to detachable electrical connectors and, more particularly, to detachable electrical connectors that are designed to operate in a harsh environment such as in proximity to the exterior of a nuclear reactor vessel.

2. Related Art

The safe operation of a nuclear reactor requires a reliable indication of the bulk reactor coolant temperature. This coolant temperature is typically monitored with thermocouples located inside the reactor vessel. The electrical cables connected to these in-vessel thermocouples are then routed to electrical connectors through a penetration either at the top or the bottom of the reactor vessel. These connectors are typically mated and demated in conjunction with the vessel disassembly and reassembly and often require unscheduled maintenance to meet operability requirements due to inservice damage. In addition, some of the existing connector designs rely on age sensitive materials and as a result require routine replacement to maintain environmental qualification.

As is well known, the cables routed from the thermocouples, as well those routed from the connectors to the instrumentation room, generally comprise a mineral-insulated metal sheathed cable having at least one, and normally several, electrical conductors, such as metal wires, surrounded by compacted mineral insulation, such as magnesium oxide or alumina oxide, and enclosed in a protective metal sheath, such as stainless steel. While the compacted magnesium oxide has high insulation properties, it is hydroscopic and therefore must be kept dry in order to protect the integrity of its insulative properties.

There are known connectors for mineral-insulated metal-sheathed cables which employ bodies of organic or elastomeric material to seal the joint necessarily formed when the components of the connector are brought together. The use of such organic or elastomeric materials has disadvantages, especially where the connector is used in a harsh environment, such as exists in the vicinity of a nuclear reactor. For example, an elevated temperature shortens the effective life of the organic or elastomeric material, causing a loss of sealing integrity. Also, exposure to nuclear radiation causes degradation of the resilience of organic or elastomeric materials. Further, the chemical spray resulting from a pressure boundary leak can cause deterioration of organic or elastomeric materials.

Current practices for joining an electrical connector to a thermocouple generally employ either an epoxy sealant and or a compression fitting. The epoxy sealant is an organic material as mentioned above and is limited by the environmentally qualified life of the epoxy. The replacement and/or recovery of the critical electrical properties of these connectors are time consuming, costly and a tedious process that has to be performed in a highly radioactively contaminated environment. The recovery efforts required for these critical connectors have also resulted in the delay of power plant startups, which is extremely costly.

Compression fittings, such as those disclosed in U.S. Pat. Nos. 4,618,198 and 5,301,213, eliminate the qualified life issues related to the epoxy connections, however, the size of the mechanical fitting causes mechanical interference problems with the installation of the CET (Core Exit Thermocouple) protective sleeve over the connectors. The fittings may rotate and become loose from the twisting of the protective sleeve as a result of these interferences and/or from improperly restraining the fitting during connector mating and demating. The result of these actions is a failed connector and the loss of the thermocouple signal.

Accordingly, it is an object of this invention to provide a mechanical attachment of the connector to the cable that does not use any age sensitive organic materials and has a qualified environmental life that exceeds the typical 40-60 year-life of a commercial reactor.

It is a further object of this invention to provide a mechanical connector joint that is smaller than can be achieved with the use of a compression fitting and eliminates the sharp edges of a compression fitting that reduces the likely occurrence of damage as a result of interference with installation and removal of the protective sleeve.

It is an additional object of this invention to provide such a connector that has no parts subject to mechanical loosening during connector mating and demating or twisting of the protective sleeve.

### SUMMARY OF THE INVENTION

These and other objects are achieved by the improved electrical connector of this invention that detachably connects a cable having a metal sheath enclosing a first conductor, to a second conductor. The improved electrical connector of this invention includes a first elongated, tubular, metal housing section having a longitudinal portion with a diameter at a first end that is sized to closely receive and prepared to be metallurgically joined to the sheath of the cable carrying the first conductor. The electrical connector also includes a second elongated, tubular, metal housing section having a first end, which is sized to mate with the second end of the first housing section. The second end of the first housing section and the first end of the second housing section have abutting surfaces that are prepared to be mechanically or metallurgically joined. The second end of the second housing section is formed to be detachably connected to a mating second electrical connector. An elongated, electrically conductive pin is supported by the second housing section with a first end of the pin adapted to electrically connect with the first conductor and a second end of the pin formed to electrically interface with a complementary electrically conductive pin on a second electrical connector that is electrically connected to the second conductor.

In the preferred arrangement, the first end of the first housing section is constructed to be brazed to the sheath of the cable. Preferably, the second end of the first housing section and the first end of the second housing section are similarly brazed at an appropriately machined interface, e.g., a lap joint.

In the preferred embodiment, the opening in the sheath of the cable through which the first conductor extends is filled with epoxy and desirably an electrical insulator spacer is positioned between the sheath and the elongated, electrically conductive pin. The electrical insulator includes a passage through which the first conductor can be threaded. Preferably, the electrical insulator is a ceramic plate or disc. In one embodiment, the electrically conductive pin is supported by the second end of the second housing section and the first end of the electrically conductive pin is a crimp bucket which can be crimped to the first conductor to establish a firm electrical connection between the first conductor and the elongated, electrically conductive pin.

### BRIEF DESCRIPTION OF THE DRAWINGS

A further understanding of the invention can be gained from the following description of the preferred embodiments when read in conjunction with the accompanying drawings in which:

FIG. 1 is a perspective view of the receptacle connector of this invention with a portion thereof cut away to show the internal connection to an electrical lead; and

FIG. 2 is a partial perspective view of a plug connector of this invention with portions cut away to show the internal connections.

### DESCRIPTION OF THE PREFERRED EMBODIMENTS

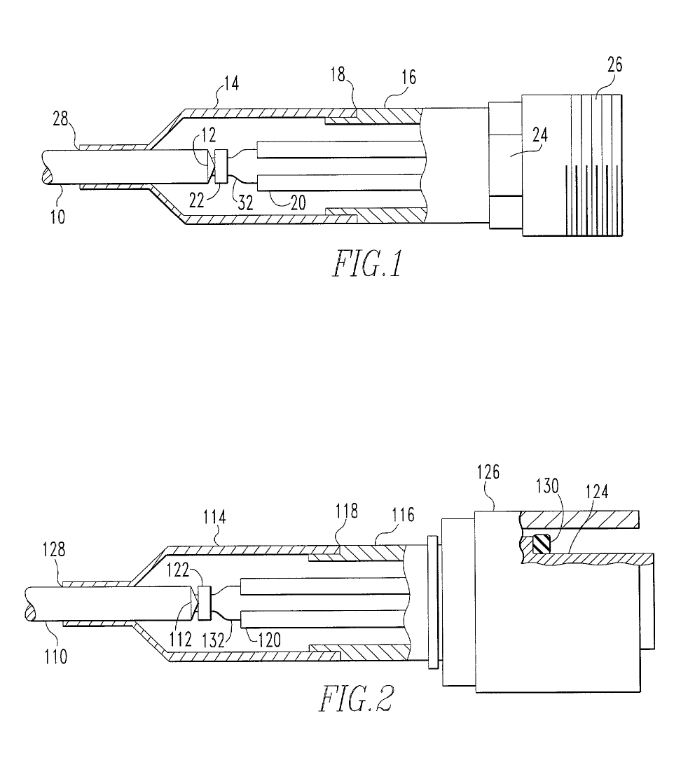

The thermocouple leads that extend through reactor vessels are typically mineral or ceramic insulated metal sheathed cables that comprise at least one electrical conductor and typically more, such as metal wires, that are surrounded by compacted mineral or ceramic insulation, such as magnesium oxide, and are enclosed in a protective metal sheath, such as stainless steel. The terminating end of such a cable is illustrated by reference character 10 in FIG. 1 where it mates with a first electrical connector housing section 14 which is preferably also constructed from stainless steel. The first electrical connector housing section 14 has a reduced diameter first end that closely surrounds the cable 10 and is formed to be brazed to the stainless steel sheath of the cable 10 at the interface 28. The sheath on the cable is cut back from the electrical leads 32 which extend through the cable 10 and are insulated from one another by the mineral or ceramic insulation retained within the sheath. The end of the sheath is sealed with an epoxy 12 to retain the ceramic insulation. The electrical leads 32, two of which are shown in this embodiment, are threaded through spaced holes in a ceramic spacer 22. The ceramic spacer 22 maintains the electrical separation between the leads 32. The leads 32 are connected to the electrical pins 20 through a suitable connection such as a crimp bucket at the pin 20/leads 32 interface.

As shown in FIG. 1, the receptacle connector of this invention includes a second, elongated, tubular housing section 16 which is adapted to be coupled to the second end of the first housing section 14 at a mating interface 18. The interface 18 can be joined by brazing at a lap joint as shown or other suitable metallurgical joints can be used or the mating interface 18 can be coupled by a threaded or mechanical connection. The electrically conductive pins 20 terminate at a second end at space terminals 24 within the male screw receptacle 26. The terminals 24 are designed to mate with complementary terminals on the plug connector shown in FIG. 2. The pins 20 are supported cantilevered from the second end of the second housing portion 16 and insulated from the tubular shell of the second housing section. It should be appreciated that other detachable mechanical couplings can be substituted for the threaded connector 26 and coupling nut arrangement 126 on the receptacle and plug connectors illustrated in FIGS. 1 and 2 without departing from the scope of this invention.

In practice, a firm connection can be made between the cable 10 and the connector by stripping back the sheath of the cable 10 to expose a suitable length of the leads 32 and threading the cable sheath through the narrow end of the first housing section 14 to which it can then be brazed. The open end of the cable sheath is epoxyed to retain the insulation. The ceramic spacer is threaded over the leads 32 and the leads 32 are then connected to the first end of the electrically conductive pins 20. The second section of the housing 18 can then be affixed to the first housing section 14 by brazing. Thereby, a strong and hermetically sealed connection is obtained between the field cable 10 and the connector.

FIG. 2 illustrates a complementary plug connector that is connected to the interfacing end of field cable 110 that is required to be disconnected from the thermocouple cable 10 during servicing of the core of the reactor. The field cable 110 is constructed similar to the cable 10 and is brazed at the interface 128 to a first housing section 114 of the plug connector. The leads 132 of the field cable 110 are threaded through the ceramic spacer 122 and connected to the electrical pins 120 in the same manner described with respect to the receptacle connector illustrated in FIG. 1. The electrically conductive pins 120 terminate at their other end in electrical contacts 124, which are designed to mate with the contacts 24 previously described. The connector contacts are bonded to the connector using glass to metal seal technology. The use of glass to metal seal technology is a widely used method of insulating the electrical connectors from the contacts. The second housing section 118 of the plug connector also includes an interfacial seal 130 shown in FIG. 2, that is a gasket installed between the two connector halves illustrated in FIGS. 1 and 2. In the preferred embodiment, the interfacial seal is an inorganic material such as a crushable metal seal (e.g. copper, nickel) or GRAFOIL that is impervious to the operating environment of a nuclear reactor. Desirably, the interfacial seal is a GRAFOIL gasket that does not require periodic replacement, is impervious to the operating environment of a nuclear reactor and does not require routine replacement based on a number of “crush ”cycles. Such a seal is described in more detail in U.S. Pat. No. 5,785,544, assigned to the assignee of this invention. A coupling nut 126 surrounds the interfacial seal and the terminal ends 124 of the electrically conductive pins 120 and is designed to mate with and screw over the threads 26 on the receptacle connector illustrated in FIG. 1.

In operation, a male/female interface or other mechanical connection is provided to connect the terminals 24 with the complementary terminals 124 and the two sets of terminals can be aligned through the use of a keyway or a bayonet and socket arrangement. After alignment, the coupling nut 126 is screwed onto the threads 26 to complete the connection between the receptacle connector of FIG. 1 and the plug connector of FIG. 2.

The method for assembling the plug connector of FIG. 2 to the field cable 110 is the same as that illustrated above for assembling the thermocouple cable 10 to the receptacle connector. Furthermore, it should be appreciated that though the plug connector has been described as being attached to the field cable 110 and the receptacle connector has been described as connected to the thermocouple cable 10, a reciprocal arrangement can be provided without departing from the scope of this invention. Preferably, the exterior housing and coupling threads and nut of the connector of this invention is constructed of stainless steel because of its strength and resistance to the harsh environment in which it is to be exposed. In addition, a protective sleeve formed from a metal tube is installed over the thermocouple and field cable connectors after the connectors are demated to permit reactor assembly/disassembly and to provide mechanical protection for the connectors.

While specific embodiments of the invention have been described in detail, it will be appreciated by those skilled in the art that various modifications and alternatives to those details could be developed in light of the overall teachings of the disclosure. For example, the field cables can consist of more than two leads with the provision in the connector of a corresponding number of electrically conductive pins. Accordingly, the particular embodiments disclosed are meant to be illustrative only and not limiting as the scope of the invention which is to be given the full breadth of the appended claims and any and all equivalents thereof.

What is claimed is:

1. An electrical connector that detachably connects a cable having a metal sheath enclosing a first conductor, to a second conductor, comprising:
a first elongated, tubular, metal housing section having a longitudinal portion with a diameter at a first end that is sized to closely receive and prepared to be metallurgically joined to the sheath of the cable carrying the first conductor;
a second elongated, tubular, metal housing section having a first end which is sized to mate with the second end of the first housing section, the second end of the first housing section and the first end of the second housing section having abutting surfaces that are prepared to be mechanically or metallurgically joined, and said second housing section having a second end that is formed to be detachably connected to a mating second electrical connector; and
an elongated, electrically conductive pin, supported by the second housing section, having a first end designed to electrically connect with the first conductor and a second end that is formed to electrically interface with a complimentary electrically conductive pin on a second electrical connector that is electrically connected to the second conductor.

2. The electrical connector of claim 1 wherein the first end of the first housing section is constructed to be brazed to the sheath of the cable.

3. The electrical connector of claim 1 wherein a mating lap joint is formed between the second end of the first housing section and the first end of the second housing section.

4. The electrical connector of claim 3 wherein the mating lap joint is constructed to be brazed.

5. The electrical connector of claim 1 where in the connection between the first housing section and the second housing section is a threaded joint.

6. The electrical connector of claim 1 wherein the first electrical conductor comprises two electrical leads that are insulated from one another and the electrically conductive pin comprises two parallel, elongated terminals with the first end of each terminal is constructed to connect a corresponding one of said electrical leads and the second end of each terminal is constructed to mate with a corresponding terminal on the second electrical connector.

7. The electrical connector of claim 1 wherein an opening in the sheath of the cable through which the first conductor extends is filled with epoxy.

8. The electrical connector of claim 1 including an electrical insulator spacer positioned between the sheath and the elongated, electrically conductive pin.

9. The electrical connector of claim 8 wherein the electrical insulator includes a passage through which the first conductor can be threaded.

10. The electrical connector of claim 9 wherein the electrical insulator is a ceramic plate.

11. The electrical connector of claim 1 wherein the electrically conductive pin is supported by the second end of the second housing section.

12. The electrical connector of claim 1 wherein the first end of the electrically conductive pin is a crimp bucket.

13. A method of detachably connecting a first electrical cable having a metal sheath enclosing a first conductor to a second electrical cable for use in a hostile environment comprising:
providing a first elongated, tubular, metal housing section having a longitudinal portion with a diameter at a first end that is sized to closely receive and prepared to be metallurgically joined to the sheath of the first cable carrying the first conductor;
threading the first cable through the first end of the first elongated, tubular housing section;
brazing the sheath of the first cable to the first end of the first elongated, tubular metal housing section;
providing a second elongated, tubular, metal housing section having a first end which is sized to mate with the second end of the first housing section, the second end of the first housing section and the first end of the second housing section having abutting surfaces that are prepared to be mechanically or metallurgical joined, and said second housing section having a second end that is formed to be detachably connected to a mating second electrical connector, said second housing section supporting an elongated, electrical conductive pin having a first end designed to electrically connect with the first conductor and a second end that is formed to electrically interface with a complimentary electrically conductive pin on a second electrical connector that is electrically connected to the second conductor;
connecting the first electrical conductor to the first end of the electrically conductive pin; and
joining the second end of the first housing section to the first end of the second housing section.

14. The method of claim 13 including the step of epoxying an end of the sheath of the first cable through which the first conductor extends towards the first end of the electrically conductive pin.

15. The method of claim 13 including the step of inserting an electrical insulator between the metal sheath of the first cable and the first end of the electrically conductive pin.
